(19) United States
(12) Patent Application Publication
(10) Pub. No.: US 2011/0001964 A1
(43) Pub. Date: Jan. 6, 2011

(54) PHOTO ACOUSTIC SAMPLE DETECTOR WITH BACKGROUND COMPENSATION

(75) Inventors: Jeroen Kalkman, Utrecht (NL); Hans Willem Van Kesteren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/920,129

(22) PCT Filed: Mar. 2, 2009
(86) PCT No.: PCT/IB09/50830

§ 371 Date: Aug. 30, 2010

(30) Foreign Application Priority Data
Mar. 7, 2008 (EP) 08152494.4

(51) Int. Cl. G01J 3/44; B23P 11/00

(52) U.S. Cl. 356/301; 29/428

(57) ABSTRACT

A photo acoustic detector for detecting a concentration of a sample in a sample mixture, the photo acoustic detector has a light source for producing a light beam for exciting molecules of the sample, a light modulator for modulating an intensity of the light beam for generating pressure variations in the sample mixture, an amplitude of the pressure variations being a measure of the concentration of the sample, and an acoustic cell with an acoustic resonator for amplifying the pressure variations. Furthermore, the photo acoustic detector has a resonant pickup element for converting the pressure variations inside the acoustic resonator into a detector signal, and a processing section for processing the detector signal to generate 1) a sample signal caused by the pressure variations, and 2) a background signal caused by direct excitation of the pickup element by the light beam. The acoustic cell and the pickup element are arranged in such a way that a phase difference between the background signal and the sample signal is close to 90 degrees.

### FIELD OF THE INVENTION

This invention relates to a photo acoustic detector for detecting a concentration of a sample in a sample mixture, the photo acoustic detector comprising a light source, a light modulator, an acoustic cell with an acoustic resonator, a resonant pickup element and a processing section. The light source produces a light beam for exciting molecules of the sample. The light modulator modulates an intensity of the light beam for generating pressure variations in the sample mixture, an amplitude of the pressure variations being a measure of the concentration of the sample. The acoustic resonator amplifies the pressure variations. The pickup element converts the pressure variations into a detector signal. The processing section processes the detector signal to generate a sample signal caused by the pressure variations. This invention further relates to a method for manufacturing such a photo acoustic detector.

### BACKGROUND OF THE INVENTION

Such photo acoustic detectors are used for trace gas monitoring in industry and may in the future also be used for breath testing (asthma, alcohol, stomach disorders) or air pollution measurements. A disadvantage of amplitude modulated photo acoustic detection is that the background signal, generated by the modulated laser, is at the same frequency as the sample signal of interest. This is in contrast to wavelength modulation, where the laser is modulated at frequency f, and the signal is detected at frequency 2f. Wavelength modulation is however not possible for, e.g., NO₂ detection with a blue diode laser because the NO₂ absorption spectrum at 400 nm is much broader than the laser-diode's wavelength tuning range. If, for optimal detection, a tuning fork pickup element is situated in the light path, then part of the amplitude modulated light can lead to a direct excitation of the tuning fork and thereby the generation of a background signal that can be orders of magnitude larger than the signal corresponding to the detection limit. Because the background signal and the NO₂ signal have the same frequency, the background signal cannot be filtered out using a high-pass filter. The use of background subtraction without sacrificing the detection limit requires a very stable and known background and/or a background that is small relative to the NO₂ signal.

### OBJECT OF THE INVENTION

It is an object of the invention to provide an amplitude modulated photo acoustic detector with improved background compensation.

### SUMMARY OF THE INVENTION

According to a first aspect of the invention, this object is achieved by providing a photo acoustic detector according to the opening paragraph, wherein the processing section is arranged for processing the detector signal to generate a sample signal caused by the pressure variations, and a background signal caused by direct excitation of the pickup element by the light beam, and wherein the acoustic cell and the pickup element are arranged such that a phase difference between the background signal and the sample signal is close to 90 degrees.

The resonant pickup element, which gives extra signal enhancement, leads in combination with the acoustic resonator to a phase shift of the pressure wave signal relative to the background signal generated by absorption of light in the pickup element. This mechanism is in contrast to the background signal that can be generated in the wall of the acoustic resonator and consequently has a phase that is close to the phase of the photo acoustic signal. By, for instance, an appropriate combination of light beam diameter and acoustic resonator diameter, the wall background signal can be made small compared to the pickup elements background signal. If necessary, the signal enhancement obtained by the use of a resonant pickup element can be compromised a bit for this purpose.

In contrast to the amplitude stability necessary for background correction by subtraction, a method based on the 90° phase difference between signal and background only needs phase stability. As the background signal depends as cos θ on the relative angle, only large variations in background phase will result in a significant background signal. Once a close to 90° phase difference between the sample signal and background signal is obtained the background signal can be suppressed using phase-sensitive detection and variations in background signal will no longer influence the accuracy of the sample concentration detection. As will be elucidated below, there are several alternative ways for adjusting the phase difference between the sample signal and the background signal.

The background phase variation is mainly determined by the resonance curve of the pickup element while the photo acoustic phase (PA phase) is determined by both the pickup element and acoustic resonance. As a result, close to the resonance, there is a constant phase difference between background and NO₂ signal. In the manufacturing process, by tuning the acoustic resonance frequency to match the pickup element resonance frequency, a 90 degree phase difference between background and sample signal can be achieved, thus reducing the effect of the background. Alternatively, the cell can be adjusted to the pickup element resonance frequency by the user after manufacturing.

According to one embodiment of the invention a resonance frequency of the pickup element is essentially equal to a resonance frequency of the acoustic resonator. When those two resonance frequencies are equal, the phase difference is 90 degrees. The resonance frequencies depend on the shapes of the acoustic resonator and of the pickup element. The resonance frequency of the pickup element can, e.g., be established by carefully selecting or producing a tuning fork of the correct length during the manufacturing process.

Preferably, the photo acoustic detector further comprises phase adjusting means for adjusting the phase difference. For example, an optical power distribution of the light beam over a surface of the pickup element is adjustable.

The inventors observed that the phase of the background signal for a tuning fork depends very sensitively on the optical power distribution over the metal electrodes. After optimizing for maximum optical power transmission through the prongs of the tuning fork, the amount of optical power has a certain distribution over the electrodes. Together with the electrode sensitivity this leads to a background signal at a certain phase angle. By adjusting the alignment of the laser beam, the phase of the background signal can be adjusted such that the background signal at the sample signal phase is zero. The background phase is then at 90 degrees relative to the sample signal. This could be achieved with only a very small loss in optical transmission (˜1%), thus not affecting the sample signal strength.

Alternatively, the resonance frequency of the acoustic resonator is adjustable, e.g., by changing a length of a buffer volume in the acoustic cell. This enables the manufacturer or user to make the phase difference close to 90 degrees and to adjust the phase difference when, e.g., the manufacturing process results in variations in the resonance properties of the acoustic resonators and pickup elements.

According to another aspect of the invention, a method for manufacturing a photo acoustic detector is provided, comprising a step of filling the acoustic cell with a sample mixture, not comprising the sample, a step of modulating the intensity of the light beam for generating pressure variations in the sample mixture, a step of acquiring the detector signal from the resonant pickup element, and a step of arranging the acoustic cell and the pickup element such that the sample signal is minimized and the background signal is maximized in order to obtain a close to 90 degrees phase difference between the background signal and the sample signal.

When the sample mixture has a zero or close to zero concentration of the sample, the sample signal should be (close to) zero and the background signal should account for (most of) the detector signal. As described above, the arranging of the acoustic cell and the pickup element may be performed in different ways. For example, careful selection of a tuning fork of the correct length such that the acoustic resonance frequency matches the pickup element resonance frequency may result in a close to 90 degrees phase difference. Alternatively, the optical power distribution of the light beam over the surface of the pickup element may be adjusted or the acoustic cell may be provided with a suitable buffer volume. These and other aspects of the invention are apparent from and will be elucidated with reference to the embodiments described hereinafter.

### BRIEF DESCRIPTION OF THE DRAWINGS

In the drawings:

FIG. 1 shows a perspective view on part of a photo acoustic detector,

FIG. 2 schematically shows an embodiment of a photo acoustic detector with buffer volumes,

FIG. 3 shows a block diagram of a photo acoustic detector according to the invention,

FIG. 4 shows a block diagram of a photo acoustic detector with means for compensating for drift of the modulation frequency, and

FIG. 5 shows a block diagram of a photo acoustic detector with means for compensating for drift in the sensor's sensitivity.

### DETAILED DESCRIPTION OF THE INVENTION

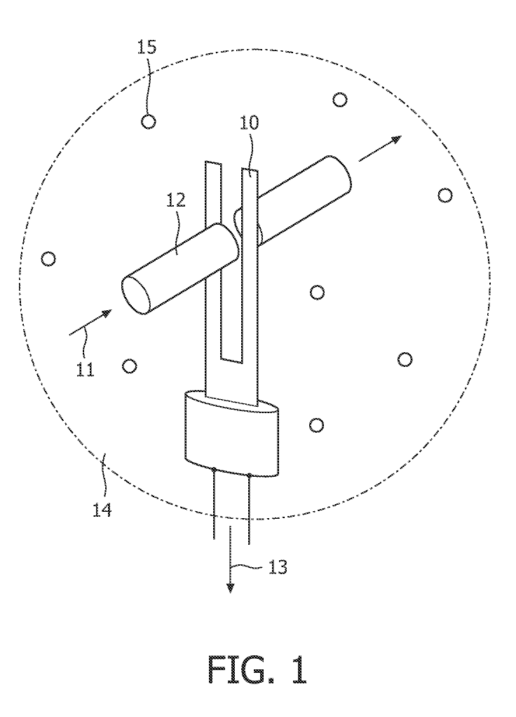

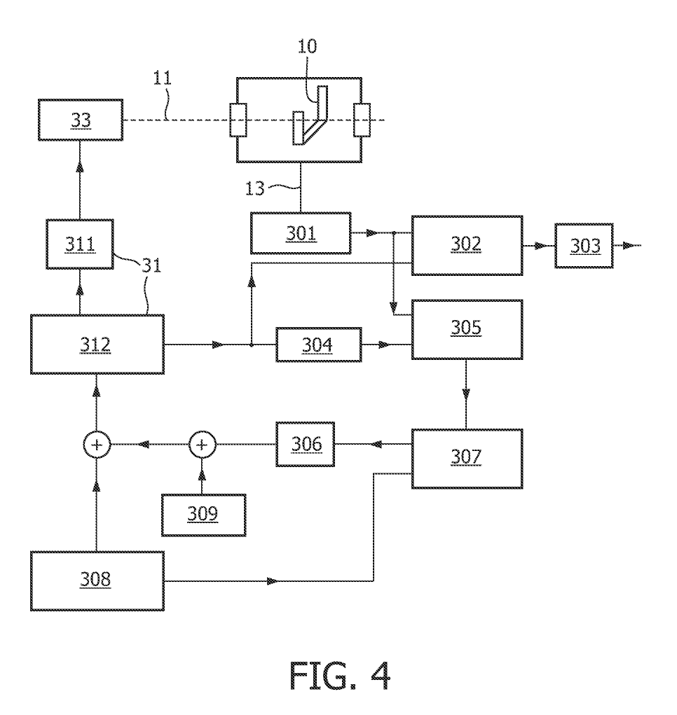

FIG. 1 shows a perspective view on part of a photo acoustic detector. An amplitude modulated laser beam 11 passes through a gas mixture 14. The gas mixture 14 comprises a low concentration of sample molecules 15. The laser beam 11 excites part of the sample molecules. Sample molecules returning from an excited state to the ground state cause a local temperature increase. The varying intensity of the laser light 11 causes pressure waves in the gas mixture 14. The pressure waves can be detected as sound waves using a resonant pickup element, e.g., in the form of a piezoelectric tuning fork10. The tuning fork 10 may be a quartz tuning fork. An acoustic resonator 12 amplifies the sound waves. The tuning fork 10 converts the sound signal into a detector signal 13 that is led to a processing unit, which will be described in detail with reference to FIGS. 3 and 4.

It is an advantage of the tuning fork 10, that it is much more sensitive and accurate in detecting the pressure waves. A disadvantage of the use of a tuning fork 10 instead of a microphone is that direct excitation of the tuning fork 10 by the laser beam 11 leads to the generation of a background signal at the same frequency as the sample signal. According to the invention the electric signal 13 from the tuning fork 10 is used to generate a sample signal representing the pressure variations and a background signal representing the direct excitation of the tuning fork 10 by the laser beam 11. To enable the processing section to generate these two signals, the photo acoustic detector is arranged such that the phase difference between the background signal and the sample signal is close to 90 degrees. This may, e.g., be achieved by using an acoustic resonator 12 and a tuning fork 10 with such a shape and dimension that their respective resonance frequencies are essentially equal. For example, in the manufacturing process of the detector, the length of the prongs of the tuning fork 10 is adjusted to obtain a tuning fork 10 with a resonance frequency that is very close to the resonance frequency of the acoustic resonator 12.

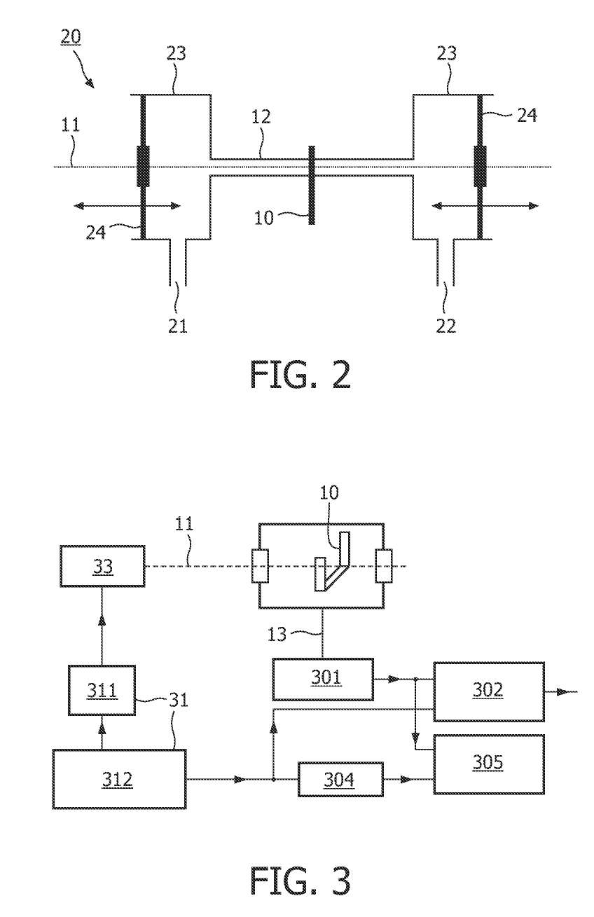

Preferably, the photo acoustic detector comprises means for adjusting the phase difference directly after the manufacturing process. Alternatively, the adjustments are made later, when the detector is in use. One example of such an adjustable detector is shown in FIG. 2 and will be described below. Alternatively, the phase difference may be adjusted by aligning the laser beam 11 in such a way that the optical power distribution of the light beam 11 over the surface of the tuning fork 10 is such that the resonance frequency of the tuning fork 10 matches the resonance frequency of the acoustic resonator 12. The inventors have observed that the phase of the background signal depends very sensitively on the optical power distribution over the metal electrodes of a quartz tuning fork.

FIG. 2 schematically shows an embodiment of a photo acoustic detector 20 with buffer volumes 23. The photo acoustic detector 20 in FIG. 2 comprises all elements already described above with reference to FIG. 1. In principle the resonant pickup element 10 can also be configured as a resonant MEMS sensor incorporating a pressure sensitive cantilever or membrane. The photo acoustic detector 20 further comprises two buffer volumes 23 with adjustable side walls 24, a gas inlet 21 and a gas outlet 22. This photo acoustic detector may be used for, e.g., breath analysis. When a user exhales, the exhaled breath enters a gas cell via the gas inlet 21. The breath is then analyzed using the laser beam 11, pickup element 10 and acoustic resonator 12 and leaves the photo acoustic detector 20 via the gas outlet 22. On both sides of the acoustic resonator 12 small non-resonant volumes 23 are added with a radius larger than the acoustic resonator radius. The position of at least one wall 24 of at least one of the volumes 23 is adjustable. These volumes 23 can for instance be connected to the gas inlet 21 and outlet of the cell 22. Depending on the length of these volumes 23 they will couple weakly or a bit more strongly to the acoustic resonator 12. By an appropriate choice of the side wall 24 positions the acoustic resonance frequency can be fine-tuned to the pickup elements resonance frequency (thus setting the phase difference to 90 degrees). For example, with an acoustic resonator 12 having a length close to or equaling half of the acoustic wave length corresponding to the amplitude modulation frequency of the light intensity, the length of the additional volumes 23 may be adjusted around a length of a quarter of the wavelength corresponding to the modulation frequency.

FIG. 3 shows a block diagram of a photo acoustic detector according to the invention. In addition to some of the elements already discussed above, FIG. 3 shows a light source 33 for producing the light beam 11 and a light modulator 31 for modulating the intensity of the laser beam 11. The light modulator comprises a laser driver 311 for driving the light source 33 and a frequency generator 312 for providing the required frequency to the laser driver 311. The other parts 301-305 shown in FIG. 3 represent structural and/or functional elements of the processing section of the photo acoustic detector 20. It is to be noted that FIG. 3 is just a schematic representation of an exemplary embodiment of a photo acoustic according to the invention. In other embodiments, similar functions may be performed by alternative means and in an alternative way.

In the embodiment shown in FIG. 3, an amplifier 301 amplifies the electric signal 13 generated by the pickup element 10. The amplified signal is directed into a first synchronous detector 302. The first synchronous detector 302 also has the modulation frequency as an input (from the frequency generator 312). The first synchronous detector 302 is used for in-phase detection of the detector signal 13. Because the 90 degrees shifted phase of the background signal, the output signal of the first synchronous detector 302 only depends on the sample concentration and not on the direct excitation of the tuning fork 10 by the laser light 11. A 90 degrees phase shifter 304 and a second synchronous detector 305 are used for extracting the (out-of phase) background signal from the detector signal 13. The signal from synchronous detector 305 can be used in the manufacturing process to optimize the 90 degrees phase difference of signal and background. During normal operation only the signal from synchronous detector 302 will be used in the embodiment shown in FIG. 3.

FIG. 4 shows a block diagram of a photo acoustic detector 20 with means for compensating for drift of the power modulation frequency. Due to the high quality factor of a quartz-tuning fork pickup element 10, the power modulation frequency of the laser can easily drift away from the optimal modulation frequency. The out-of-phase signal can be advantageously applied for controlling this frequency. This can be implemented either in an optimization routine before an actual sample measurement is performed or in the form of a continuously active electronic control loop.

First, close to resonance, the phase of the background signal depends strongly on modulation frequency. In case of a measurement of only the background signal the modulation frequency of the laser can be tuned to the resonance frequency such that the background signal remains at a constant phase (and thus at 90 degrees relative to the sample signal). Alternatively, the optimal modulation frequency can be determined from a maximization of the (out-of phase) background signal.

Second, a stable electronic control loop can be implemented as shown in FIG. 4. The frequency for laser power modulation (several tens of kHz) is modulated by a second frequency generator 308 around the (tuning fork) resonance frequency at a frequency f₁ (few Hz to several tens of Hz) and with a frequency modulation amplitude of several Hz. The tuning fork 10 should have a sufficiently “low” Q such that it passes the response to the frequency modulation. The typical Q of 4000 should be reduced to for instance 1000 to obtain a response time of 30 ms suitable for a 10 Hz modulation. The sample signal is obtained after “in-phase” synchronous detection and low-pass filtering (to filter out f₁). With the low pass filter 303 after the first synchronous detector 302 the signal-to-noise can be brought back to the original level assuming that the amplifier 301 adds no extra noise to the (reduced) signal and noise from the (lower Q) tuning fork 10. The out-of-phase signal is, after synchronous detection, demodulated with a third synchronous detector 307 using f₁ as reference. Exactly at resonance the feedback signal is at 2*f₁ and the signal demodulated at f₁ is zero. The low-pass filtered output (from second low-pass filter 306) forms an offset level for the DC reference voltage 309 that is used as input for the frequency generator. Such a measurement can be performed while simultaneously measuring the sample concentration.

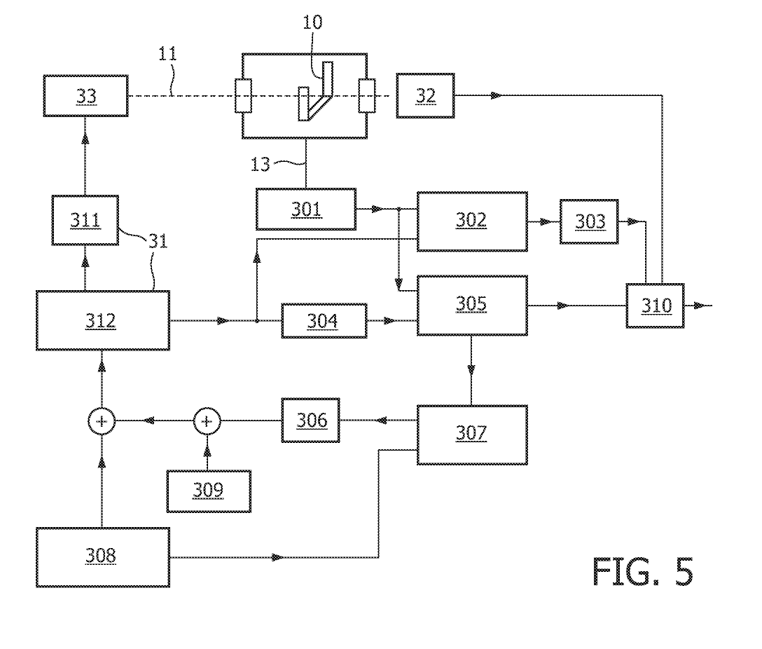

FIG. 5 shows a block diagram of a photo acoustic detector with means for compensating for drift in the sensor's sensitivity. FIG. 5 shows all elements of FIG. 4 and additionally comprises a photo detector 32 for measuring the power of the laser beam 11 and a sensor drift compensation unit 310. The background signal depends on the quality factor/pickup sensitivity of the tuning fork 10 and the intensity of the light beam. Therefore, the background signal can advantageously be used for determining sensor pickup drift. The sensor pickup drift compensation unit 310 uses the detected laser power from the photo detector 32 for normalizing the background signal to a reference light power. The sensor pickup drift compensation unit then divides the normalized background signal by the initial background signal (at reference light power) during factory calibration. Thus a compensation factor is obtained that can be used during sample measurements.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A photo acoustic detector for detecting a concentration of a sample in a sample mixture, the photo acoustic detector comprising:
a light source for producing a light beam for exciting molecules of the sample,
a light modulator for modulating an intensity of the light beam for generating pressure variations in the sample mixture, an amplitude of the pressure variations being a measure of the concentration of the sample,
an acoustic cell with an acoustic resonator for amplifying the pressure variations,
a resonant pickup element for converting the pressure variations inside the acoustic resonator into a detector signal,
a processing section for processing the detector signal to generate
a sample signal caused by the pressure variations, and
a background signal caused by direct excitation of the pickup element by the light beam,
the acoustic cell and the pickup element being arranged such that a phase difference between the background signal and the sample signal is close to 90 degrees.

2. A photo acoustic detector as claimed in claim 1, wherein a resonance frequency of the pickup element is essentially equal to a resonance frequency of the acoustic resonator.

3. A photo acoustic detector as claimed in claim 1, further comprising phase adjusting means for adjusting the phase difference.

4. A photo acoustic detector as claimed in claim 3, wherein the phase adjusting means comprise means for adjusting an optical power distribution of the light beam over a surface of the pickup element.

5. A photo acoustic detector as claimed in claim 3, wherein the phase adjusting means comprise means for adjusting a resonance frequency of the acoustic resonator.

6. A photo acoustic detector as claimed in claim 5, wherein the acoustic cell further comprises at least one buffer volume, and wherein the means for adjusting the resonance frequency of the acoustic resonator are arranged to adjust a length of the at least one buffer volume.

7. A photo acoustic detector as claimed in claim 1, wherein the processing section is arranged to adjust a modulation frequency of the light modulator in order to match a resonance frequency of the pickup element.

8. A photo acoustic detector as claimed in claim 1, further comprising a power sensor for determining a power of the light beam and wherein the processing section is further arranged for determining a reduction of the tuning fork sensitivity over time, based on the power of the light beam, the background signal and reference values for the power of the light beam and the background signal.

9. A photo acoustic detector according to claim 1, wherein the processing section comprises means for phase sensitive detection for generating the sample signal and the background signal.

10. A photo acoustic detector according to claim 1, wherein the resonant pickup element is a piezoelectric tuning fork.

11. A method for manufacturing a photo acoustic detector having a light source for producing a light beam; a light modulator for modulating an intensity of the light beam, an acoustic cell with an acoustic resonator, and a resonant pickup element, the method comprising the steps of:
filling the acoustic cell with a sample mixture, not comprising the sample,
modulating the intensity of the light beam for generating pressure variations in the sample mixture,
acquiring a detector signal from the resonant pickup element,
generating a sample signal from the pressure variations and a background signal from direct excitation of the pickup element by the light beam, and
arranging the acoustic cell and the pickup element such that the sample signal is minimized and the background signal is maximized in order to obtain a close to 90 degrees phase difference between the background signal and the sample signal.
